(19) United States
(12) Patent Application Publication
(10) Pub. No.: US 2021/0010950 A1
(43) Pub. Date: Jan. 14, 2021

(54) INSPECTION DEVICE, INSPECTION METHOD, AND COMPUTER READABLE MEDIUM

(71) Applicant: MITSUBISHI ELECTRIC CORPORATION, Tokyo (JP)

(72) Inventors: Keisuke KITO, Tokyo (JP); Kiyoto KAWAUCHI, Tokyo (JP); Takumi YAMAMOTO, Tokyo (JP); Hiroki NISHIKAWA, Tokyo (JP)

(73) Assignee: MITSUBISHI ELECTRIC CORPORATION, Tokyo (JP)

(21) Appl. No.: 17/034,779

(22) Filed: Sep. 28, 2020

Related U.S. Application Data
(63) Continuation of application No. PCT/JP2018/020804, filed on May 30, 2018.

(51) Int. Cl. G01N 21/956; G01N 21/88

(52) U.S. Cl. CPC G01N 21/95607; G01N 21/8851

(57) ABSTRACT

A correlation value calculation unit calculates a correlation value between input data input to an inspection-targeted apparatus whose internal specifications are unknown and output data for the input data from the inspection-targeted apparatus. A state transition determination unit analyzes in a time-series manner, a plurality of correlation values calculated by the correlation value calculation unit for a plurality of pieces of input data and a plurality of pieces of output data for the plurality of pieces of input data, and determines whether or not a state transition has occurred in the inspection-targeted apparatus.

### CROSS REFERENCE TO RELATED APPLICATIONS

This application is a Continuation of PCT International Application No. PCT/JP2018/020804, filed on May 30, 2018, which is hereby expressly incorporated by reference into the present application.

### TECHNICAL FIELD

The present invention relates to an inspection device, an inspection method, and an inspection program.

### BACKGROUND ART

In a security inspection for a control apparatus (for example, a vehicle-mounted apparatus), an abnormal communication packet or an abnormal input data (for example, a communication packet or input data that violate a format) not described in specifications of the control apparatus is given to the control apparatus. Then, behavior of the control apparatus is monitored to check whether or not any vulnerabilities remain in the control apparatus. Sending the abnormal communication packet such as a format violation to an inspection-targeted apparatus, monitoring the behavior, and checking for presence of a vulnerability are called fuzzing. Since it is not realistic to perform the fuzzing blindly and by a full search, it is common to perform the fuzzing while changing the input data in a situation where the specifications of the inspection-targeted apparatus are known to some extent.

Meanwhile, giving arbitrary input data to the inspection-targeted apparatus whose specifications are unknown (black box), estimating an internal operation of the inspection-targeted apparatus based on the behavior of the inspection-targeted apparatus, and examining whether or not the inspection-targeted apparatus has any vulnerabilities is referred to as a penetration test or a penetrating test. The penetration test is performed in such a way that the tester estimates the internal operation of the inspection-targeted apparatus skillfully like an artisan and estimates what kind of communication packet, input data, or parameter should be given to the inspection-targeted apparatus so as to find the vulnerability. A tester with such an artisanship is referred to as a pentester and required to have a specialized technique and ability.

Patent Literature 1 discloses a system that operates with all parameters, a state transition model described in specifications and easily verifies an operation that should not be performed for a reason of security. However, the system of Patent Literature 1 is based on a premise that the specifications of the inspection target are known.

Patent Literature 2 discloses a method of storing an input/output signal of a vehicle-mounted apparatus or the like as time series data and acquiring a log when a time change equal to or greater than a certain threshold value occurs in the input/output signal.

Patent Literature 3 discloses a method of performing a security evaluation on a vehicle-mounted ECU (Engine Control Unit). More specifically, Patent Literature 3 discloses a method of finding a vulnerability based on behavior when an order violation or a format violation in a vehicle-mounted network communication occurs while monitoring a state of the vehicle-mounted ECU in a situation where a debugger is connected to the vehicle-mounted ECU.

Also, Patent Literature 4 discloses a method of performing a security evaluation on a vehicle-mounted ECU. In Patent Literature 4, a debugger or the like is connected to the vehicle-mounted ECU, and further, a display apparatus such as a meter is monitored by a camera. Further, in Patent Literature 4, a vulnerability included in the vehicle-mounted ECU is found based on behavior when communication or an input of abnormal data is performed or based on behavior when communication or an input of a communication order violation is performed.

### CITATION LIST

### Patent Literature

Patent Literature 1: JP2009-75886A

Patent Literature 2: JP2013-148966A

Patent Literature 3: JP2017-112598A

Patent Literature 4: JP2017-214049A

### SUMMARY OF INVENTION

### Technical Problem

When the penetration test is performed, it is necessary to know the specifications of the inspection-targeted apparatus to some extent. However, the penetration test is a black box test and a test in which a third party who does not know the specifications of the inspection-targeted apparatus finds a vulnerability in security. Therefore, in the penetration test, if the specifications of the inspection-targeted apparatus are unknown, a pentester with a special skill and ability is required.

Since the vulnerability is easily found in a state transition of the inspection-targeted apparatus, it is necessary to estimate the state transition and a transition condition. However, a method of estimating the state transition of a black box system is not disclosed in any patent literature. For this reason, there is a problem that the state transition of the black box system cannot be estimated unless a person who has an artisanship skill, such as a pentester, is present.

One of the main objects of the present invention is to solve the problem described above. More specifically, the present invention mainly aims to obtain a configuration possible to estimate a state transition of a black box system.

### Solution to Problem

An inspection device according to the present invention includes:

a correlation value calculation unit to calculate a correlation value between input data input to an inspection-targeted apparatus whose internal specifications are unknown and output data for the input data from the inspection-targeted apparatus; and

a state transition determination unit to analyze in a time-series manner, a plurality of correlation values calculated by the correlation value calculation unit for a plurality of pieces of input data and a plurality of pieces of output data for the plurality of pieces of input data, and determine whether or not a state transition has occurred in the inspection-targeted apparatus.

### Advantageous Effects of Invention

According to the present invention, it is possible to estimate a state transition of a black box system based on a correlation value between input data and output data.

### BRIEF DESCRIPTION OF DRAWINGS

FIG. 1 is a diagram illustrating a system configuration example according to a first embodiment;

FIG. 2 is a diagram illustrating a hardware configuration example of an inspection device according to the first embodiment;

FIG. 3 is a diagram illustrating a functional configuration example of the inspection device according to the first embodiment;

FIG. 4 is a diagram illustrating a relationship between a value of input data and a value of output data, and a relationship between the value of the input data and a correlation value according to the first embodiment;

FIG. 5 is a flowchart illustrating an operation example of the inspection device according to the first embodiment;

FIG. 6 is a diagram illustrating a functional configuration example of an inspection device according to a second embodiment; and

FIG. 7 is a flowchart illustrating an operation example of the inspection device according to the second embodiment.

### DESCRIPTION OF EMBODIMENTS

Hereinafter, embodiments of the present invention will be described with reference to the drawings. In the following description of the embodiments and the drawings, the same reference numerals indicate the same or corresponding parts.

### First Embodiment

### Description of Configuration

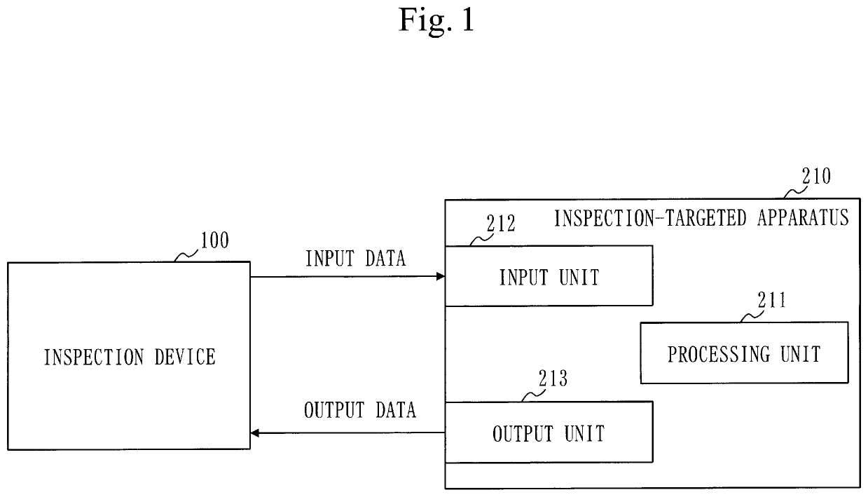

FIG. 1 illustrates a system configuration example according to the present embodiment.

In the present embodiment, an inspection device 100 and an inspection-targeted apparatus 210 are connected to each other. The inspection-targeted apparatus 210 is a black box system whose specifications are unknown. The inspection device 100 determines whether or not a state transition has occurred in the inspection-targeted apparatus 210, and performs a penetration test. More specifically, the inspection device 100 analyzes a correlation value between input data to the inspection-targeted apparatus 210 and output data from the inspection-targeted apparatus 210 to determine whether or not the state transition has occurred in the inspection-targeted apparatus 210.

Besides, an operation performed in the inspection device 100 corresponds to an inspection method and an inspection program.

The inspection-targeted apparatus 210 is a computer.

The inspection-targeted apparatus 210 includes a processing unit 211, an input unit 212, and an output unit 213.

The input unit 212 receives input data from the inspection device 100.

The processing unit 211 performs a process (calculation) on the input data.

The output unit 213 transmits output data to the inspection device 100, which is a processing result of the processing unit 211.

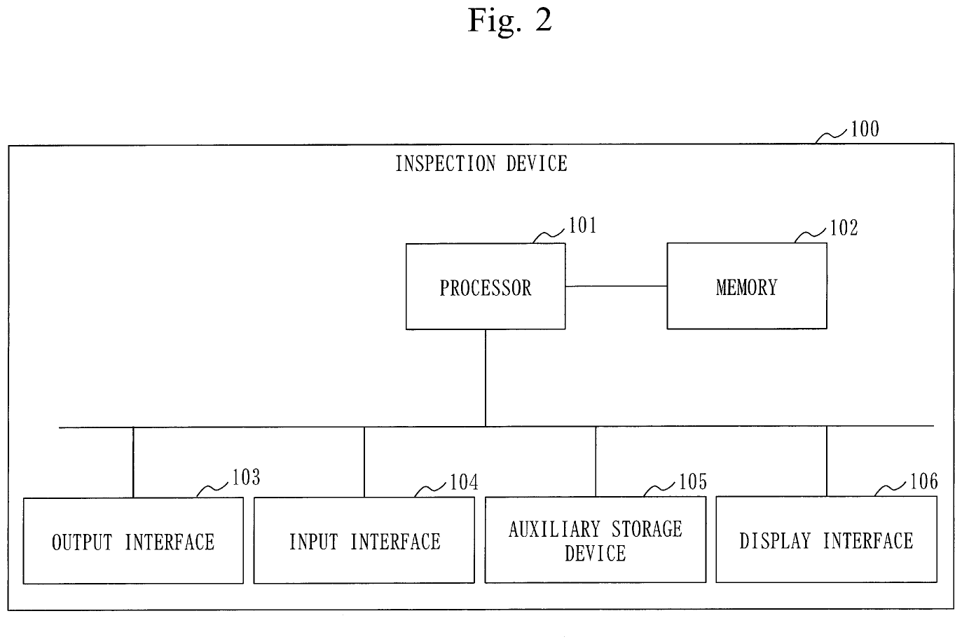

Next, a hardware configuration example of the inspection device 100 will be described with reference to FIG. 2.

The inspection device 100 is a computer.

The inspection device 100 includes as hardware, a processor 101, a memory 102, an output interface 103, an input interface 104, an auxiliary storage device 105, and a display interface 106.

The processor 101 executes a program and performs a calculation process.

The memory 102 temporarily stores the program executed by the processor 101. Also, the memory 102 stores a calculation result of the processor 101.

The output interface 103 and the input interface 104 function as interfaces with communication paths to and from the inspection-targeted apparatus 210. The output interface 103 transmits to the communication path, the input data for the inspection-targeted apparatus 210, and the input interface 104 receives from the communication path, the output data from the inspection-targeted apparatus 210.

The auxiliary storage device 105 stores the program executed by the processor 101. Also, the auxiliary storage device 105 stores data and the like which are referred to by the processor 101.

The display interface 106 functions as an interface with a display connected to the inspection device 100.

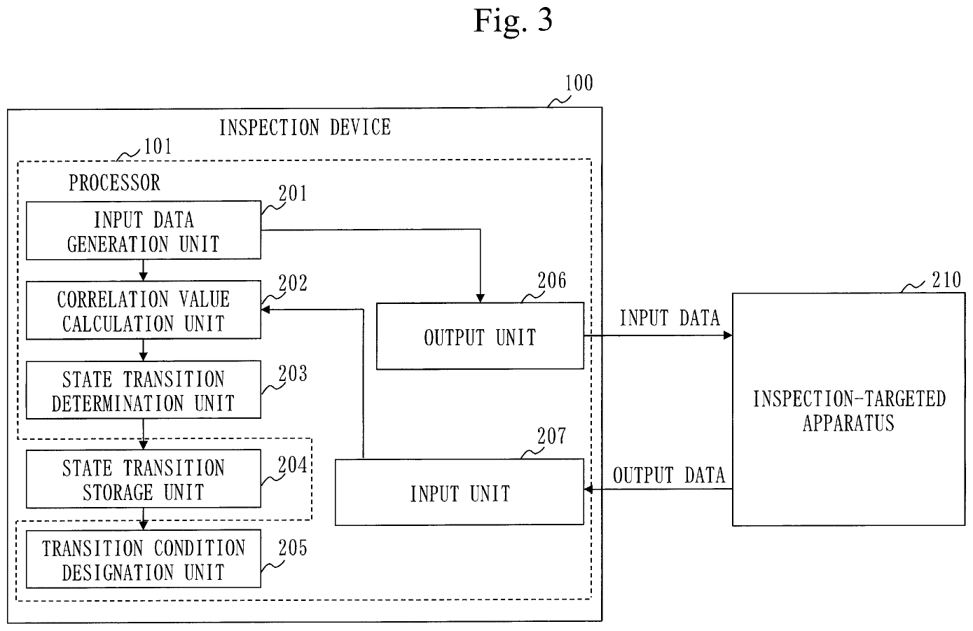

FIG. 3 illustrates a functional configuration example of the inspection device 100 according to the present embodiment.

The inspection device 100 includes an input data generation unit 201, a correlation value calculation unit 202, a state transition determination unit 203, a state transition storage unit 204, a transition condition designation unit 205, an output unit 206, and an input unit 207.

The input data generation unit 201, the correlation value calculation unit 202, the state transition determination unit 203, the transition condition designation unit 205, the output unit 206, and the input unit 207 are implemented by a program.

The program that implements the input data generation unit 201, the correlation value calculation unit 202, the state transition determination unit 203, the transition condition designation unit 205, the output unit 206, and the input unit 207 is stored in the auxiliary storage device 105. The program that implements the input data generation unit 201, the correlation value calculation unit 202, the state transition determination unit 203, the transition condition designation unit 205, the output unit 206, and the input unit 207 is loaded from the auxiliary storage device 105 into the memory 102 and is executed by the processor 101.

FIG. 3 illustrates a state in which the processor 101 executes the program that implements the input data generation unit 201, the correlation value calculation unit 202, the state transition determination unit 203, the transition condition designation unit 205, the output unit 206, and the input unit 207.

On the other hand, the state transition storage unit 204 is implemented by the memory 102 or the auxiliary storage device 105.

The input data generation unit 201 generates the input data for the inspection-targeted apparatus 210.

The output unit 206 transmits the input data generated by the input data generation unit 201 to the inspection-targeted apparatus 210.

The input unit 207 receives the output data which is from the input data generation unit 201.

The correlation value calculation unit 202 acquires the input data from the input data generation unit 201 and acquires from the input unit 207, the output data corresponding to the input data. Then, the correlation value calculation unit 202 calculates a correlation value between the input data and the output data.

Besides, the process performed by the correlation value calculation unit 202 corresponds to a correlation value calculation process.

The state transition determination unit 203 analyzes in a time-series manner, a plurality of correlation values calculated by the correlation value calculation unit 202 for a plurality pieces of input data and a plurality pieces of output data for the plurality pieces of input data. Then, the state transition determination unit 203 determines whether or not the state transition has occurred in the inspection-targeted apparatus 210. More specifically, when a change equal to or greater than a threshold value has occurred in a timewise progress in the correlation values, the state transition determination unit 203 determines that the state transition has occurred in the inspection-targeted apparatus 210.

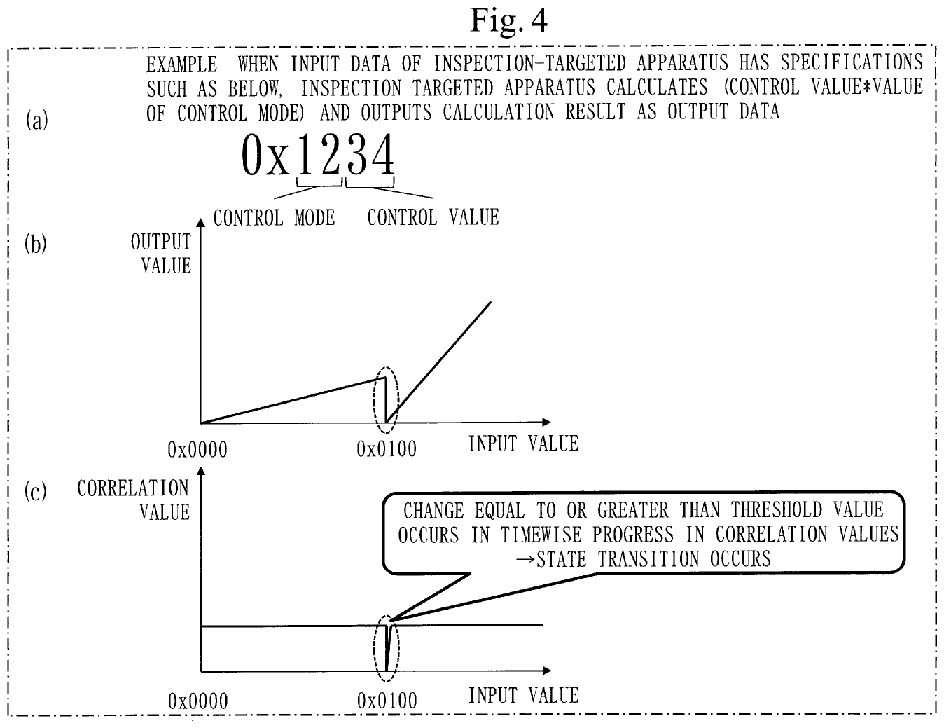

For example, when the input data has specifications illustrated in (a) of FIG. 4, the inspection-targeted apparatus 210 calculates (control value×value of control mode) and outputs the calculation result as the output data.

(b) of FIG. 4 illustrates a relationship between the value of the input data and the value of the output data. (c) of FIG. 4 illustrates a relationship between the value of the input data and the correlation value.

In examples of FIG. 4, as illustrated in (b) of FIG. 4, the value of the input data is incremented.

When the value of the input data becomes “0x0100”, the relationship between the value of the input data and the value of the output data changes. That is, as illustrated in (c) of FIG. 4, when the value of the input data becomes “0x0100”, the change equal to or greater than the threshold value occurs in the correlation value. In this way, when the change equal to or greater than the threshold value occurs in the timewise progress in the correlation values, the state transition determination unit 203 determines that the state transition has occurred in the inspection-targeted apparatus 210.

Besides, the process performed by the state transition determination unit 203 corresponds to a state transition determination process.

When it is determined by the state transition determination unit 203 that the state transition has occurred in the inspection-targeted apparatus 210, the state transition storage unit 204 stores a fact that the state transition has occurred in the inspection-targeted apparatus 210.

The transition condition designation unit 205 designates the input data corresponding to the correlation value at which a change equal to or greater than the threshold value has occurred, as a condition for occurrence of the state transition. In the examples of FIG. 4, the input data of “0x0100” is designated as the condition for the occurrence of the state transition.

### Description of Operation

Next, an operation example of the inspection device 100 according to the present embodiment will be described.

The inspection device 100 estimates a state of the inspection-targeted apparatus 210 in a situation in which internal specifications of the inspection-targeted apparatus 210 are unknown. However, the inspection device 100 can recognize a communication standard regarding an input/output of the inspection-targeted apparatus 210, for example, a protocol (CAN (Controller Area Network) or the like) to be used. Further, the inspection device 100 can measure an ON/OFF voltage level of the output data from the inspection-targeted apparatus 210.

The inspection device 100 treats all of the input data and the output data of the inspection-targeted apparatus 210 as analysis targets, no matter what the standard of the input/output is or no matter which of analog or digital the input/output is.

Further, a debugger or the like cannot be connected to the inspection-targeted apparatus 210, and the inspection device 100 cannot recognize states of a memory and a register inside the inspection-targeted apparatus 210.

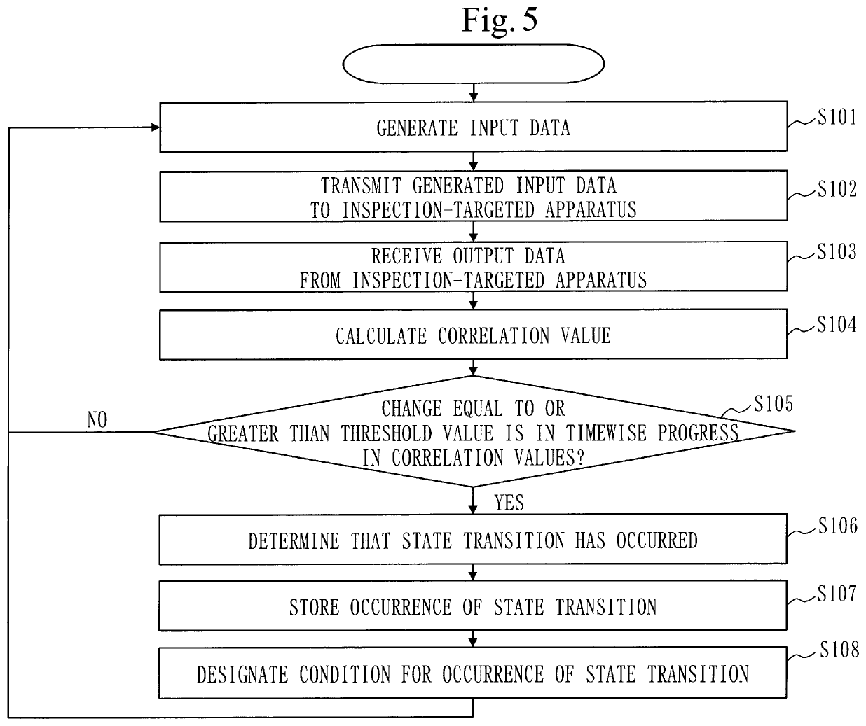

FIG. 5 illustrates an operation example of the inspection device 100.

First, in step S101, the input data generation unit 201 generates input data for the inspection-targeted apparatus 210.

A method of generating the input data is not particularly limited, but the input data generation unit 201 may generate the input data by using, for example, a random number. Further, as illustrated in FIG. 4, the input data generation unit 201 may incrementally change the value of the input data. Further, when a communication format is known, the input data generation unit 201 may generate the input data by randomly shifting a part where the value changes.

Next, in step S102, the output unit 206 transmits the input data to the inspection-targeted apparatus 210.

In the inspection-targeted apparatus 210, the input unit 212 receives the input data. Next, the processing unit 211 processes the input data. Then, the output unit 213 transmits output data that is the processing result of the processing unit 211.

In step S103, in the inspection device 100, the input unit 207 receives the output data which is from the inspection-targeted apparatus 210.

Next, in step S104, the correlation value calculation unit 202 calculates a correlation value.

That is, the correlation value calculation unit 202 acquires the input data from the input data generation unit 201 and acquires the output data from the input unit 207. Then, the correlation value calculation unit 202 calculates the correlation value between the acquired input data and the acquired output data.

Although a method of calculating the correlation value is not limited, the correlation value calculation unit 202 calculates the correlation value by, for example, a correlation function. The correlation values calculated by the correlation value calculation unit 202 are stored in a time-series manner in the memory 102 or the auxiliary storage device 105.

Next, in step S105, the state transition determination unit 203 determines whether or not a change equal to or greater than a threshold value has occurred in a timewise progress in the correlation values.

That is, the state transition determination unit 203 calculates in the time-series manner, the progress in the correlation values stored in the memory 102 or the auxiliary storage device 105 in the time-series manner. Specifically, the state transition determination unit 203 calculates the timewise progress in the correlation values by performing a differential calculation. If there is a change equal to or greater than a predetermined threshold value in the timewise progress in the correlation values, the state transition determination unit 203 determines that the state transition has occurred in the inspection-targeted apparatus 210 (step S106).

On the other hand, if there is no change equal to or greater than the threshold value in the timewise progress in the correlation values, the process returns to step S101, and the input data generation unit 201 generates new input data.

When it is determined in step S106 by the state transition determination unit 203 that the state transition has occurred, the state transition storage unit 204 stores a fact that the state transition has occurred in the inspection-targeted apparatus 210. Specifically, the state transition storage unit 204 stores a fact that one state in a state transition diagram has been made.

Next, in step S107, the transition condition designation unit 205 designates a condition for an occurrence of the state transition.

Specifically, the transition condition designation unit 205 designates the input data corresponding to the correlation value at which the change equal to or greater than the threshold value has occurred, as the condition for the occurrence of the state transition. For example, the transition condition designation unit 205 designates the input data of “0x0100” in FIG. 4 as the condition for the occurrence of the state transition.

After that, the process returns to step S101, and the input data generation unit 201 generates new input data.

The inspection device 100 repeats the operations of the above steps S101 to S108 until a user gives a stop instruction.

### Description of Effect of Embodiment

According to the present embodiment, it is possible to estimate the state transition of the black box system based on the correlation value between the input data and the output data. Thus, according to the present embodiment, it is possible to estimate the state transition of the black box system whose specifications are unknown even if a person who has specialized knowledge is not present, such as a pen tester. Then, by focusing on the estimated state transition and performing the penetration test, it is possible to efficiently perform the penetration test.

### Second Embodiment

According to the first embodiment, every time it is determined that the state transition has occurred, the fact that the state transition has occurred is stored. However, in the first embodiment, when the state transition that has occurred in the past occurs again in the inspection-targeted apparatus 210, redundant descriptions for the same state transition are stored. For example, it is assumed that the state of the inspection-targeted apparatus 210 proceeds from state A to state B to state C to state B. Since the inspection device 100 does not distinguish between a first state transition to the state B and a second state transition to the state B, the state transition to the state B is redundantly stored.

In the present embodiment, a configuration for detecting occurrence of such redundant state transitions and preventing redundant storages will be described.

### Description of Configuration

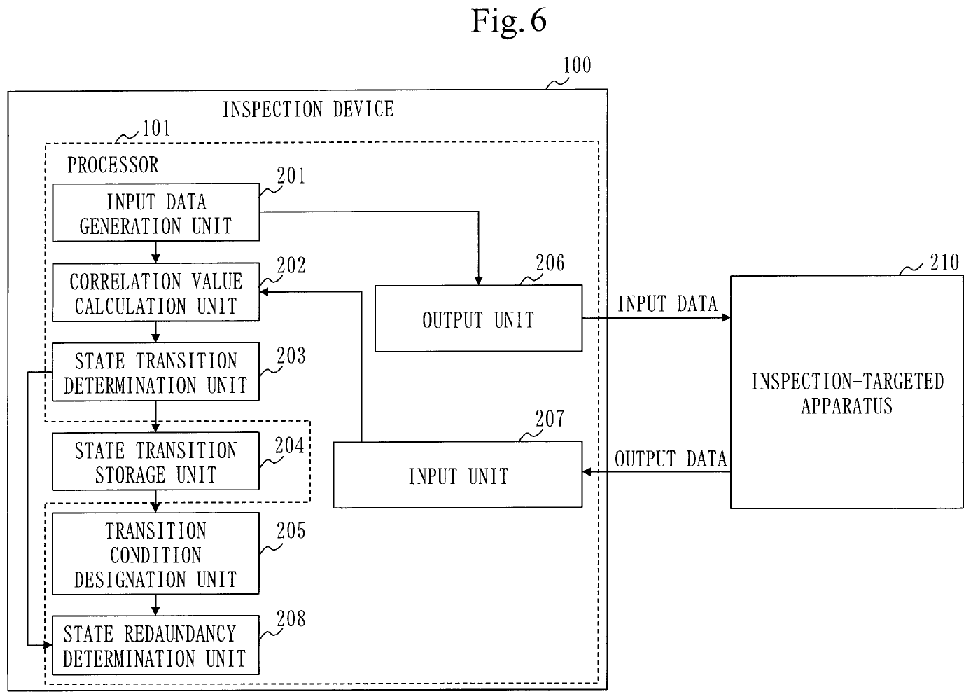

FIG. 6 illustrates a functional configuration example of the inspection device 100 according to the present embodiment.

In FIG. 6, a state redundancy determination unit 208 is added as compared with the configuration of FIG. 3.

When it is determined by the state transition determination unit 203 that the state transition has occurred in the inspection-targeted apparatus 210, the state transition storage unit 204 stores the fact that the state transition has occurred, as with the first embodiment. In the present embodiment, the state transition storage unit 204 further stores a change in the correlation value (a change equal to or greater than the threshold value in the correlation value) when the state transition determination unit 203 determines that the state transition has occurred.

When it is determined by the state transition determination unit 203 that the change equal to or greater than the threshold value occurs in the timewise progress in the correlation values, the state redundancy determination unit 208 determines whether or not a change similar to the determined change equal to or greater than the threshold value has occurred in the past. That is, the state redundancy determination unit 208 determines whether or not the change similar to the change equal to or greater than the threshold value which is determined by the state transition determination unit 203 has been stored in the state transition storage unit 204. If the change similar to the change equal to or greater than the threshold value has occurred in the past, the state redundancy determination unit 208 determines that the same state transition as the state transition that has occurred in the past in the inspection-targeted apparatus 210 has occurred again in the inspection-targeted apparatus 210.

When it is determined by the state redundancy determination unit 208 that the same state transition as the state transition that has occurred in the past in the inspection-targeted apparatus 210 has occurred again in the inspection-targeted apparatus 210, the state transition determination unit 203 does not determine that the state transition has occurred in the inspection-targeted apparatus 210. Further, the state transition storage unit 204 does not store the fact that the state transition has occurred.

On the other hand, when it is not determined by the state redundancy determination unit 208 that the same state transition as the state transition that has occurred in the past in the inspection-targeted apparatus 210 has occurred again in the inspection-targeted apparatus 210, the state transition determination unit 203 determines that the state transition has occurred in the inspection-targeted apparatus 210. Further, the state transition storage unit 204 stores the fact that the state transition has occurred. Further, the state transition storage unit 204 stores a change in the correlation value (a change equal to or greater than the threshold value in the correlation value) when the state transition determination unit 203 determines that the state transition has occurred.

Differences from the first embodiment will be mainly described below.

Matters not described below are the same as those in the first embodiment.

### Description of Operation

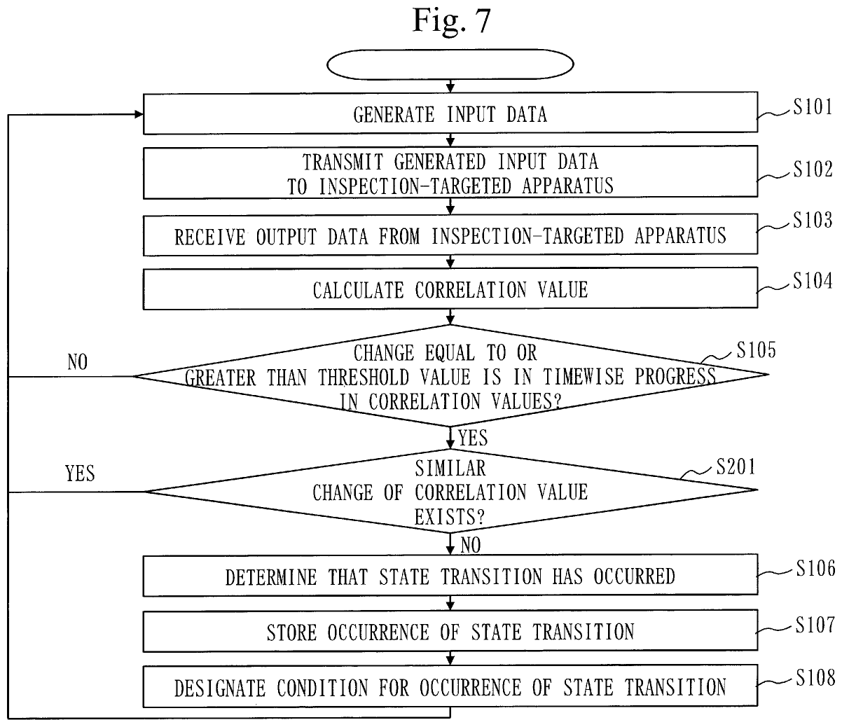

FIG. 7 illustrates an operation example of the inspection device 100 according to the present embodiment.

Since steps S101 to S105 are the same as those described in the first embodiment, the descriptions are omitted.

In step S201, the state redundancy determination unit 208 determines whether or not the change similar to the change equal to or greater than the threshold value which is determined by the state transition determination unit 203 has occurred in the past. That is, the state redundancy determination unit 208 determines whether or not the change similar to the change equal to or greater than the threshold value which is determined by the state transition determination unit 203 has been stored in the state transition storage unit 204. Note that, a “similar width” is decided by a system administrator in advance.

If the change similar to the change equal to or greater than the threshold value has occurred in the past, the state redundancy determination unit 208 determines that the same state transition as the state transition that has occurred in the past in the inspection-targeted apparatus 210 has occurred again in the inspection-targeted apparatus 210.

Then, the process returns to step S101, and the input data generation unit 201 generates new input data.

That is, if the similar change has occurred in the past, the state transition determination unit 203 does not determine that the state transition has occurred in the inspection-targeted apparatus 210. Further, the state transition storage unit 204 does not store the fact that the state transition has occurred in the inspection-targeted apparatus 210.

On the other hand, if the change similar to the change equal to or greater than the threshold value has not occurred in the past, the process proceeds to step S106. Then, the state transition determination unit 203 determines that the state transition has occurred in the inspection-targeted apparatus 210.

Since operations of steps S106 and S108 are the same as those described in the first embodiment, the descriptions are omitted.

In the present embodiment, in step S107, the state transition storage unit 204 stores the fact that the state transition has occurred, and further, stores the change in the correlation value (the change equal to or greater than the threshold value in the correlation value) when the state transition determination unit 203 determines that the state transition has occurred.

### Description of Effect of Embodiment

According to the present embodiment, it is possible to detect the occurrence of the redundant state transitions and prevent the redundant storages. Therefore, according to the present embodiment, it is possible to efficiently perform the penetration test.

### Third Embodiment

In the first and second embodiments, since the relationship between the input data and the occurrence of the state transition is not considered, effective input data cannot be generated. “Effective input data” is input data that is prone to cause the state transition.

In the present embodiment, the input data generation unit 201 analyzes the input data designated by the transition condition designation unit 205 as the condition for the occurrence of the state transition, and estimates the input data that is prone to cause the state transition in the inspection-targeted apparatus 210. The input data generation unit 201 according to the present embodiment defines, for example, an evaluation function of genetic algorithm as a magnitude of a time series change in the correlation value, and generates the input data. By doing this, the input data generation unit 201 can generate the effective input data.

Although the embodiments of the present invention have been described above, two or more of these embodiments may be combined and implemented.

Alternatively, one of these embodiments may be partially implemented.

Alternatively, two or more of these embodiments may be partially combined and implemented.

Besides, the present invention is not limited to these embodiments, and various modifications can be made as necessary.

### Description of Hardware Configuration

Finally, supplementary descriptions of a hardware configuration of the inspection device 100 will be given.

The processor 101 illustrated in FIG. 2 is an IC (Integrated Circuit) that performs processing.

The processor 101 is a CPU (Central Processing Unit), a DSP (Digital Signal Processor), or the like.

The memory 102 illustrated in FIG. 2 is a RAM (Random Access Memory).

The auxiliary storage device 105 illustrated in FIG. 2 is a ROM (Read Only Memory), a flash memory, an HDD (Hard Disk Drive), or the like.

The output interface 103 and the input interface 104 illustrated in FIG. 2 are electronic circuits that execute a data communication process.

The output interface 103 and the input interface 104 are, for example, communication chips or NICs (Network Interface Cards).

The auxiliary storage device 105 also stores an OS (Operating System).

Then, at least a part of the OS is executed by the processor 101.

While executing at least the part of the OS, the processor 101 executes a program that implements functions of the input data generation unit 201, the correlation value calculation unit 202, the state transition determination unit 203, the transition condition designation unit 205, the output unit 206, and the input unit 207.

The processor 101 executes the OS, thus task management, memory management, file management, communication control, and the like are performed.

Also, at least one of information, data, signal values, and variable values indicating processing results of the input data generation unit 201, the correlation value calculation unit 202, the state transition determination unit 203, the transition condition designation unit 205, the output unit 206, and the input unit 207, is stored in at least one of the memory 102, the auxiliary storage device 105, and a register and a cache memory in the processor 101.

In addition, the program that implements the functions of the input data generation unit 201, the correlation value calculation unit 202, the state transition determination unit 203, the transition condition designation unit 205, the output unit 206, and the input unit 207 may be stored in a portable storage medium such as a magnetic disk, a flexible disk, an optical disk, a compact disk, a Blu-ray (registered trademark) disk, or a DVD.

In addition, “unit” of the input data generation unit 201, the correlation value calculation unit 202, the state transition determination unit 203, the transition condition designation unit 205, the output unit 206, and the input unit 207 may be read as “circuit” or “step” or “procedure” or “process”.

Further, the inspection device 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Besides, in the present specification, a superordinate concept of the processor 101, the memory 102, a combination of the processor 101 and the memory 102, and the processing circuit is referred to as “processing circuitry”.

That is, each of the processor 101, the memory 102, the combination of the processor 101 and the memory 102, and the processing circuit is a specific example of the “processing circuitry”.

### Reference Signs List

100: inspection device, 101: processor, 102: memory, 103: output interface, 104: input interface, 105: auxiliary storage device, 106: display interface, 201: input data generation unit, 202: correlation value calculation unit, 203: state transition determination unit, 204: state transition storage unit, 205: transition condition designation unit, 206: output unit, 207: input unit, 208: state redundancy determination unit, 210: inspection-targeted apparatus, 211: processing unit, 212: input unit, 213: output unit.

1. An inspection device comprising:
processing circuitry
to calculate a correlation value between input data input to an inspection-targeted apparatus whose internal specifications are unknown and output data for the input data from the inspection-targeted apparatus; and
to analyze in a time-series manner, a plurality of correlation values calculated for a plurality of pieces of input data and a plurality of pieces of output data for the plurality of pieces of input data, inspect whether or not a change equal to or greater than a threshold value has occurred in a timewise progress in the correlation values, and when it is determined that the change equal to or greater than the threshold value has occurred in the timewise progress in the correlation values, determine that a state transition has occurred in an internal state of the inspection-targeted apparatus.

2. The inspection device according to claim 1,
wherein the processing circuitry designates as a condition for occurrence of the state transition, input data corresponding to a correlation value at which the change equal to or greater than the threshold value has occurred.

3. The inspection device according to claim 1,
wherein the processing circuitry stores a fact that the state transition has occurred in the internal state of the inspection-targeted apparatus, when it is determined that the state transition has occurred in the internal state of the inspection-targeted apparatus.

4. The inspection device according to claim 1,
wherein the processing circuitry determines whether or not a change similar to the change equal to or greater than the threshold value determined has occurred in the past, when it is determined that the change equal to or greater than the threshold value has occurred in the timewise progress in the correlation values.

5. The inspection device according to claim 4,
wherein when the change similar to the change equal to or greater than the threshold value has occurred in the past, the processing circuitry determines that the state transition that has occurred in the inspection-targeted apparatus in the past has occurred again in the inspection-targeted apparatus.

6. The inspection device according to claim 5,
wherein when it is not determined that the state transition that has occurred in the inspection-targeted apparatus in the past has occurred again in the inspection-targeted apparatus, the processing circuitry determines that the state transition has occurred in the inspection-targeted apparatus.

7. The inspection device according to claim 2,
wherein the processing circuitry analyzes the input data designated as the condition for the occurrence of the state transition, and estimates input data which is prone to cause the state transition in the inspection-targeted apparatus.

8. An inspection method comprising:
calculating, a correlation value between input data input to an inspection-targeted apparatus whose internal specifications are unknown and output data for the input data from the inspection-targeted apparatus; and
analyzing, in a time-series manner, a plurality of correlation values calculated for a plurality of pieces of input data and a plurality of pieces of output data for the plurality of pieces of input data, inspecting whether or not a change equal to or greater than a threshold value has occurred in a timewise progress in the correlation values, and when it is determined that the change equal to or greater than the threshold value has occurred in the timewise progress in the correlation values, determining that a state transition has occurred in an internal state of the inspection-targeted apparatus.

9. A non-transitory computer readable medium storing an inspection program which causes a computer to execute:
a correlation value calculation process of calculating a correlation value between input data input to an inspection-targeted apparatus whose internal specifications are unknown and output data for the input data from the inspection-targeted apparatus; and
a state transition determination process of analyzing in a time-series manner, a plurality of correlation values calculated by the correlation value calculation process for a plurality of pieces of input data and a plurality of pieces of output data for the plurality of pieces of input data, inspecting whether or not a change equal to or greater than a threshold value has occurred in a timewise progress in the correlation values, and when it is determined that the change equal to or greater than the threshold value has occurred in the timewise progress in the correlation values, determining that a state transition has occurred in an internal state of the inspection-targeted apparatus.
